(19) United States
(12) Patent Application Publication
(10) Pub. No.: US 2012/0066438 A1
(43) Pub. Date: Mar. 15, 2012

(54) NON-VOLATILE MEMORY DEVICE, OPERATION METHOD THEREOF, AND DEVICE HAVING THE SAME

(76) Inventors: Han Bin YOON, Hwaseong-si (KR); Jang Hwan Kim, Suson-si (KR); Jung Been Im, Anyang-si (KR)

(21) Appl. No.: 13/233,744

(22) Filed: Sep. 15, 2011

(30) Foreign Application Priority Data
Sep. 15, 2010 (KR) 10-2010-0090517

(51) Int. Cl. G06F 12/02

(52) U.S. Cl. 711/103; 711/171; 711/E12.008; 711/E12.009

(57) ABSTRACT

A memory device includes a control module to determine first data blocks needing a garbage collection, to determine second data blocks needing memory refresh among the determined first data blocks, and to execute the garbage collection first on the second data blocks.

### CROSS-REFERENCE TO RELATED APPLICATIONS

This application claims priority under 35 U.S.C. §119(a) from Korean Patent Application No. 10-2010-0090517 filed on Sep. 15, 2010, the disclosure of which is hereby incorporated by reference in its entirety.

### BACKGROUND

1. Field of the General Inventive Concept

The general inventive concept relates to garbage collection of data blocks included in a flash memory, and more particularly, to a method of efficiently managing data stored in a flash memory.

2. Description of the Related Art

The flash memory, which is used as an example of an Electrically Erasable Programmable Read-Only Memory (EEPROM), has an advantage of a Read Only Memory (ROM) preserving stored data without a power supply as well as an advantage of a Random Access Memory (RAM) where data are programmed or erased freely at the same time. Accordingly, the flash memory is widely used as a storage media of a mobile electronic device such as a cellular phone, a digital camera, a personal digital assistant PDA and a MP3 player.

### SUMMARY OF THE PRESENT GENERAL INVENTIVE CONCEPT

The present general inventive concept provides a method of managing data stored in a flash memory efficiently by helping a garbage collection to perform first on data blocks needing refresh, and devices performing the method.

Additional features and utilities of the present general inventive concept will be set forth in part in the description which follows and, in part, will be obvious from the description, or may be learned by practice of the general inventive concept.

An exemplary embodiment of the present general inventive concept is directed to an operation method of a memory device, including determining first data blocks needing a garbage collection, determining second data blocks needing refresh among determined first data blocks, and performing the garbage collection first on the second data blocks.

Determining the first data blocks determines data blocks, where the number of invalid pages among a plurality of pages included in each of a plurality of data blocks is equal to or more than a reference value, as the first data blocks.

Determining the second data blocks determines data blocks including a page, where difference between a last accessed time of a plurality of pages included in each of the first data blocks and a current time is equal to or greater than a reference time, as the second data blocks.

An exemplary embodiment of the present general inventive concept is directed to a memory device, including a flash memory including a plurality of data blocks, and a memory controller determining first data blocks needing a garbage collection among the plurality of data blocks, determining second data blocks needing refresh among the first data blocks and performing the garbage collection first on the second data blocks.

The memory controller includes a garbage collection block determination unit determining the first data blocks among the plurality of data blocks, a refresh block determination unit determining the second data blocks among the first data blocks, and a garbage collection execution unit executing the garbage collection first on the second data blocks.

The garbage collection block determination unit determines data blocks where the number of invalid pages among a plurality of pages included in each of the plurality of data blocks is equal to or more than a reference value as the first data blocks.

The refresh block determination unit determines data blocks including a page where difference between a last accessed time of a plurality of pages included in each of the first data blocks and a current time is equal to or greater than a reference time as the second data blocks.

The memory controller further includes a page mapping database storing mapping information of at least one valid page included in each of the plurality of data blocks. A time when the at least one valid page included in each of the plurality of data blocks is last accessed is stored in the page mapping database, and the refresh block determination unit determines the second data blocks by comparing a last accessed time of the at least one valid page with a current time.

An exemplary embodiment of the present general inventive concept is directed to an electronic device, including a said memory device and a processor to control an operation of the memory device. The electronic device is a PC, a tablet PC, a solid state drive (SSD) or a cellular phone.

An exemplary embodiment of the present general inventive concept is directed to a memory card, including a card interface and a second memory controller controlling data exchange between the card interface and a said memory device.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 illustrates a schematic block diagram of a memory device according to an exemplary embodiment of the present general inventive concept;

FIG. 2 illustrates a schematic block diagram of a flash memory illustrated in FIG. 1;

FIG. 3 illustrates a schematic block diagram of a memory array, a row decoder and a page buffer when a memory cell array of FIG. 2 is embodied in a three dimensional memory cell array;

FIG. 4 illustrates a schematic block diagram of a memory controller illustrated in FIG.

FIG. 5 illustrates a flowchart of an operation method of a memory controller illustrated in FIG. 1;

FIG. 6 illustrates a flowchart of a method of determining a garbage collection target block and a refresh target block among operation methods of the memory controller illustrated in FIG. 5;

FIG. 7 illustrates data blocks where a garbage collection is performed in a flash memory according to an exemplary embodiment of the present general inventive concept;

FIG. 8 illustrates data blocks where a garbage collection is performed in a flash memory according to another exemplary embodiment of the present general inventive concept;

FIG. 9 illustrates an exemplary embodiment of an electronic device including the memory controller illustrated in FIG. 1;

FIG. 10 illustrates another exemplary embodiment of the electronic device including the memory controller illustrated in FIG. 1;

FIG. 11 illustrates still another exemplary embodiment of the electronic device including the memory controller illustrated in FIG. 1;

FIG. 12 illustrates still another exemplary embodiment of the electronic device including the memory controller illustrated in FIG. 1;

FIG. 13 illustrates still another exemplary embodiment of the electronic device including the memory controller illustrated in FIG. 1;

FIG. 14 illustrates still another exemplary embodiment of the electronic device including the memory controller illustrated in FIG. 1;

FIG. 15 illustrates still another exemplary embodiment of the electronic device including the memory controller illustrated in FIG. 1; and

FIG. 16 illustrates an exemplary embodiment of a data processing device including the electronic device illustrated in FIG. 15.

### DETAILED DESCRIPTION OF THE EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular exemplary embodiments only and is not intended to be limiting. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the exemplary embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

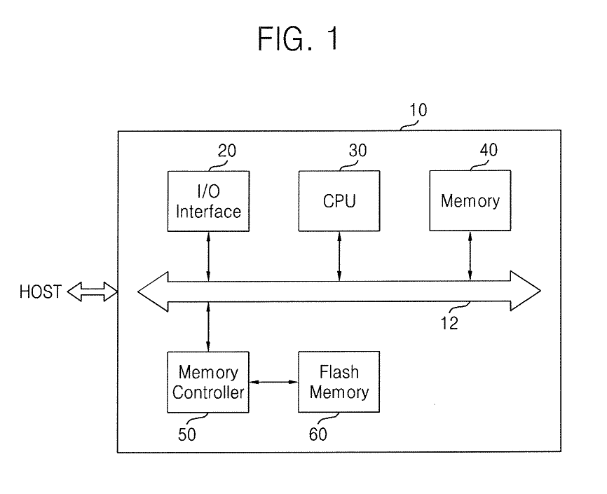

FIG. 1 illustrates a schematic block diagram of a memory device according to an exemplary embodiment of the present general inventive concept. Referring to FIG. 1, the memory device 10 may include an input/output interface 20, a central processing unit CPU 30, a memory 40, a memory controller 50 and a flash memory 60.

The input/output interface 20 interfaces data exchange between a host and the memory device 10. The input/output interface 20 receives a program command or data corresponding to the program command from the host. The input/output interface 20 also transmits a program command or data output from the host to the CPU 30 through a data bus 12.

The CPU 30 controls a general operation of the memory device 10. The CPU 30 may control data exchange between the host and the I/O interface 20. The CPU 30 also controls the memory device 10 to perform an operation in accordance with a command output from the host. The CPU 30 receives a program command or data corresponding to the program command from the host. The CPU 30 may control the memory device 10 to program data corresponding to the program command in the memory 40 or the flash memory 60. According to an exemplary embodiment, the CPU 30 transmits a program command or a control signal to program the data to the memory controller 50 so as to program data in the flash memory 60. Accordingly, the flash memory 60 may program data corresponding to the program command in a memory cell array under a control of the memory controller 50.

The memory 40 stores various kinds of data to control an operation of the memory device 10. The CPU 30 may store a program command or data corresponding to the program command output from a host in the memory 40. The memory 40 may be embodied in a non-volatile memory, e.g., a read only memory (ROM), which may store a program code controlling an operation of the CPU 30, and embodied in a volatile memory, e.g., a dynamic random access memory (DRAM), which may store data received or transmitted between a host and the CPU 30.

The memory controller 50 controls an operation of the flash memory 60. For example, the memory controller 50 may manage a memory region of the flash memory 60. The memory region may be divided into data blocks, each of the data blocks may include a plurality of pages. Accordingly, the memory controller 50 may control a data recording and/or reading operation on and/or from the memory region of the flash memory 60.

The memory controller 50 may also perform a garbage collection on a plurality of data blocks embodied in a memory cell array included in the flash memory 60. More specifically, the memory controller 50 may determine at least one first set of data blocks (hereinafter, ‘garbage collection target blocks’) which needs a garbage collection among the plurality of data blocks. Further, among the garbage collection target blocks, the memory controller 50 may determine at least one second set of data blocks (hereinafter, ‘refresh target blocks’) which needs refresh. In addition, the memory controller 50 may perform a garbage collection first on refresh target blocks. That is, the memory controller 50 may perform a garbage collection on the refresh target blocks before performing a garbage collection on the remaining garbage collection target blocks. Accordingly, data stored in a flash memory 60 may be managed more efficiently by first performing the garbage collection on the refresh blocks prior to performing refresh on the refresh target blocks.

As mentioned above, the flash memory 60 may be divided into a plurality of data blocks. Each of the data blocks may include a plurality of pages to store various kinds of data under a control of the memory controller 50. The pages of the flash memory 60, however, may become invalid. For example, to update data stored in the flash memory 60, a new page and/or new data blocks including new pages may be created, and the updated data is written to the new page. Thereafter, the original page including the old data is invalidated. However, as the number of invalidated pages increases, the flash memory 60 may become filled with invalid pages, such that the flash memory 60 may become inefficient. Thus, it may be desirable to perform a garbage collection on data blocks determined to receive a refresh process based on a number of invalid pages, as discussed further below.

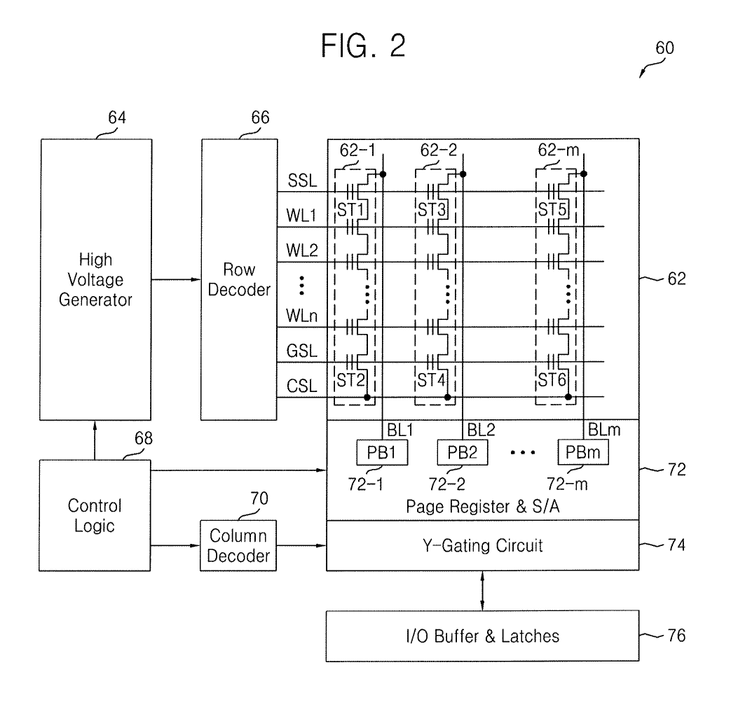

FIG. 2 illustrates a schematic block diagram of a flash memory illustrated in FIG. 1.

The flash memory 60 includes a memory cell array 62, a high voltage generator 64, a row decoder 66, a control logic 68, a column decoder 70, a page register & sense amplifier (S/A) block 72, a Y-gating circuit 74 and input/output buffer and latches 76.

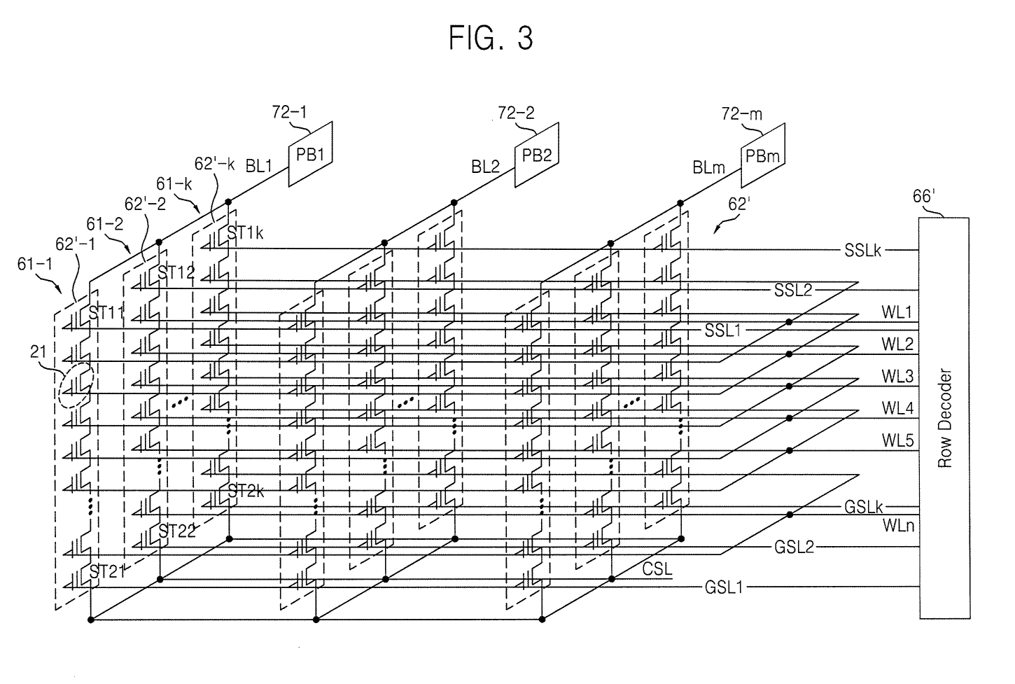

The memory cell array 62 includes a plurality of cell strings 62-1, 62-2, . . . , 62-m, where m is a natural number. Each of the plurality of cell strings 62-1, 62-2, . . . , 62-m includes a plurality of memory cells. Each cell string 62-1, 62-2, . . . , or 62-m may be laid-out or embodied on a two-dimensionally identical plane as illustrated in FIG. 2, and laid-out or embodied on three dimensionally different planes or layers as illustrated in FIG. 3.

As illustrated in FIG. 3, a first cell string 62′-1 may be laid-out on a first layer 61-1, a second cell string 62′-2 may be laid-out on a second layer 61-2 different from the first layer 61-1, and a k^{th} cell string 62′-k may be three-dimensionally laid-out on a layer 61-k different from the second layer 61-2.

A cell string 62-1 illustrated in FIG. 2 includes a plurality of memory cells connected in series between a first selection transistor ST1 connected to a bit line BL1 and a second selection transistor ST2 connected to a ground, a cell string 62-2 includes a plurality of memory cells connected in series between a third selection transistor ST3 connected to a bit line BL2 and a fourth selection transistor ST4 connected to a ground, and a cell string 62-m includes a plurality of memory cells connected in series between a fifth selection transistor ST5 connected to a bit line BLm and a sixth selection transistor ST6 connected to a ground.

Each of a plurality of memory cells included in each cell string 62-1, 62-2 . . . , or 62-m may be embodied in an Electrically Erasable Programmable Read-Only Memory (EEPROM), which may store one-bit or more. According to an exemplary embodiment, each of the plurality of memory cells may be embodied in an NAND flash memory, e.g., a single level cell (SLC) or a multi-level cell (MLC). Accordingly, each cell string 62-1, 62-2, . . . , or 62-m may be called an NAND string.

According to a control of a control logic 68, the high voltage generator 64 generates a plurality of voltages including a program voltage necessary to perform a program operation, a plurality of voltages including a read voltage necessary to perform a read operation, a plurality of voltages including a verify voltage necessary to perform a verify operation or a plurality of voltages including an erase voltage necessary to perform an erase operation, and outputs at least one voltage necessary to perform each operation to the row decoder 66.

The control logic 68 embodied as a circuit, a logic, code, or combination of them may control an operation of the high voltage generator 64, the column decoder 70 and the page buffer & sense amplifier block 72 according to a command input from outside, e.g., a program command, a read command or an erase command.

The page register & sense amplifier block 72 includes a plurality of page buffers 72-1, 72-2, . . . , 72-m. Each of the plurality of page buffers 72-1 to 72-m operates as a driver to program data in the memory cell array 62 during a program operation under a control of the control logic 68. Each of the plurality of page buffers 72-1 to 72-m may operate as a sense amplifier which may determine a threshold voltage of a memory selected among a plurality of memory cells of the memory cell array 62 during a read operation or a verify operation under a control of the control logic 68.

The column decoder 70 decodes column addresses under a control of the control logic 68 and outputs decoding signals to the Y-gating circuit 74. The Y-gating circuit 74 may control transmission of data between the page register & sense amplifier block 72 and the input/output buffer & latch block 76 in response to decoding signals output from the column decoder 70. The input/output buffer & latch block 76 may transmit data to the Y-gating circuit 74 or transmit data to outside through a data bus.

FIG. 3 illustrates a schematic block diagram of a memory array, a row decoder and a page buffer when a memory cell array of FIG. 2 is embodied in a three dimensional memory cell array. As illustrated in FIG. 3, each of a plurality of layers 61-1, 61-2, . . . , and 61-k, where k is a natural number, includes a plurality of cell strings. A plurality of layers L1 to Ln may be embodied in stack of a wafer type, stack of a chip type or cell stack. Electrical connections between layers may use a vertical electrical through element like through silicon vias (TSVs), wire bondings or bumps.

A first cell string 62′-1 embodied on a first layer 61-1 includes a plurality of non-volatile memory cells, e.g., NAND flash memory cells, connected in series between a plurality of selection transistors ST11 and ST21. A second cell string 62′-2 embodied on a second layer 61-2 includes a plurality of non-volatile memory cells, e.g., NAND flash memory cells, connected in series between a plurality of selection transistors ST12 and ST22. A k^{th} cell string 62′-k embodied on a k^{th} layer 61-k includes a plurality of non-volatile memory cells, e.g., NAND flash memory cells, connected in series between a plurality of selection transistors ST1k and ST2k.

The row decoder 66′ illustrated in FIG. 3 may supply a selection signal to each string selection line SSL1, SSL2, . . . , or SSLk connected to each gate of each first selection transistor ST11, ST12, . . . , or ST1k embodied on each layer 61-1, 61-2, . . . , or 61-k. Accordingly, each first selection transistor ST11, ST12, . . . , or ST1k may be turned on or off selectively.

Moreover, the row decoder 66′ may supply a selection signal to each ground selection line GSL1, GSL2, . . . , or GSLk connected to each gate of each second selection transistor ST21, ST22, . . . , or ST2k embodied on each layer 61-1, 61-2, . . . , or 61-k. Accordingly, each second selection transistor ST21, ST22, . . . , or ST2k may be turned on or off selectively. That is, each cell string 62′-1, 62′-2, . . . , or 62′-m embodied on each layer 21-1, 21-2, . . . , or 21-k may be selected by the row decoder 66′.

As illustrated in FIG. 3, each cell string 62′-1, 62′-2, . . . , or 62′-k may share a plurality of word lines WL1 to WLn, a common source line CSL and each bit line BL1 to BLm. In other words, each cell string embodied in a corresponding location on each layer 61-1 to 61-k may be connected to each page buffer 72-1, 72-2, . . . , or 72-m embodied in the page register and sense amplifier block 72.

The following explains an operation of the flash memory 60 assuming that a cell string 62′-1 embodied on a layer, e.g., a first layer 61-1, is selected by the row decoder 66′ among a plurality of layers 61-1 to 61-k embodied in a three dimensional memory cell array 62′.

Accordingly, the memory cell array 62 used in the present general inventive concept illustrates generally the second dimensional memory cell array 62 illustrated in FIG. 2 and the three-dimensional memory cell array 62′ illustrated in FIG. 3, and the row decoder 66 displays generally the row decoder 66 illustrated in FIG. 2 and the row decoder 66′ illustrated in FIG. 3.

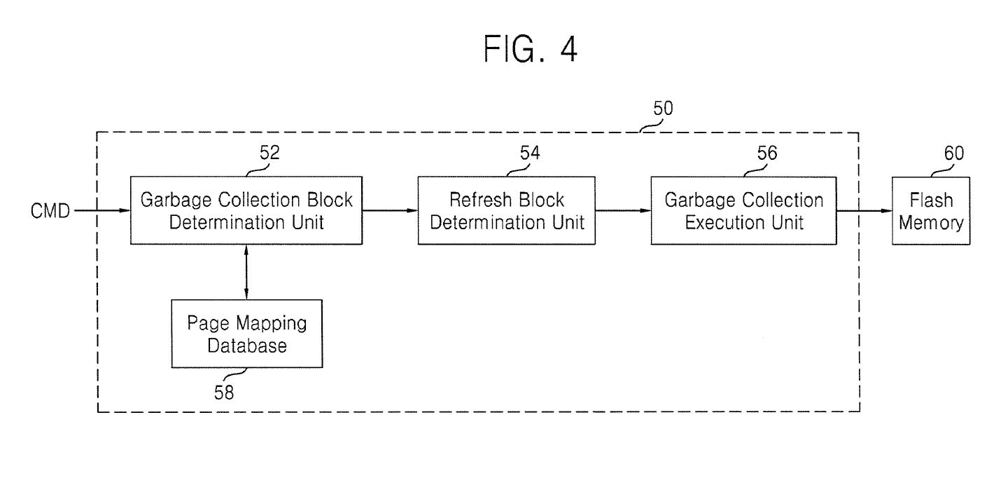

FIG. 4 illustrates a schematic block diagram of a memory controller illustrated in FIG. 1. Referring to FIGS. 1 and 4, the memory controller 50 includes a garbage collection block determination unit 52, a refresh block determination unit 54 and a garbage collection execution unit 56, and further includes a page mapping database DB 58.

The garbage collection block determination unit 52 determines data blocks which need a garbage collection, i.e., garbage collection target blocks, among a plurality of data blocks included in the flash memory 60. According to an exemplary embodiment, when a program command CMD is received from the CPU 30, the garbage collection determination unit 52 searches for data blocks where a number of invalid pages is equal to or more than a reference value among a plurality of data blocks included in the flash memory 60. The garbage collection block determination unit 52 determines data blocks where the number of invalid pages is equal to or more than a reference value as garbage collection target blocks.

The refresh block determination unit 54 determines blocks which need refresh, i.e., refresh target blocks, among garbage collection target blocks determined by the garbage collection block determination unit 54. The refresh block determination unit 54 calculates difference between a time when each of at least one valid page included in garbage collection target blocks is last accessed and a current time. The refresh block determination unit 54 determines data blocks including a page where difference between a last accessed time of the garbage collection target blocks and a current time is equal to or more than a reference time as the refresh target block.

According to another exemplary embodiment, the refresh block determination unit 56 may determine refresh target blocks even among data blocks which are not garbage collection target blocks. The refresh block determination unit 56 may determine every data block, which includes a page where difference between a last accessed time of a plurality of data blocks included in the flash memory 60 and a current time is equal to or more than a reference time, as refresh target blocks. That is, the refresh block determination unit 56 may determine refresh target blocks among a plurality of data blocks included in the flash memory 60 when a program command CMD is received from the CPU 30 or at every reference time apart from an operation of the garbage collection block determination unit 54.

The garbage collection execution unit 56 executes a garbage collection first on data blocks corresponding to refresh target blocks among garbage collection target blocks.

According to an exemplary embodiment, the garbage execution unit 56 may execute a garbage collection on data blocks, setting a priority in an order of (1) data blocks (e.g., refresh target blocks) where the number of invalid pages is more than a reference value, and a page includes a difference between a last accessed time and a current time being more than a reference time, (2) data blocks (refresh target blocks) where a page includes a difference between a last accessed time and a current time being more than a reference time, and (3) data blocks (garbage collection target blocks) where the number of invalid pages is equal to or more than a reference value. It can be appreciated that the order of priority described above is one example of an order of priority, and other priority orders may be provided by present general inventive concept.

In the page mapping database 58, times when at least one valid page included in each of a plurality of data blocks is last accessed may be stored corresponding to the each valid page. According to an exemplary embodiment, valid pages of each of a plurality of data blocks, each time when each of the valid pages is last accessed and information on an invalid page or free page may be stored in the page mapping database 58. Moreover, address information corresponding to a valid page included in each of a plurality of data blocks may be stored in the page mapping database 58.

According to an exemplary embodiment, address information corresponding to each valid page and a last accessed time may be embodied in a form of table, e.g., a mapping table, and stored in the page mapping database 58. Additionally, a reference value to determine a garbage collection target block or a reference time to determine a refresh target block may be stored in the page mapping database 58.

It is illustrated that the garbage collection block determination unit 52, the refresh block determination unit 54 and the garbage collection execution unit 56 are all included in the memory controller 50 in FIG. 4, however, the garbage collection block determination unit 52, the refresh block determination unit 54 and the garbage collection execution unit 56 may be embodied in the CPU 30 in a form of firmware, e.g., a flash translation layer. In addition, the mapping table stored in the page mapping database 58 may be embodied in a form which is stored in a memory 40 or the flash memory 60.

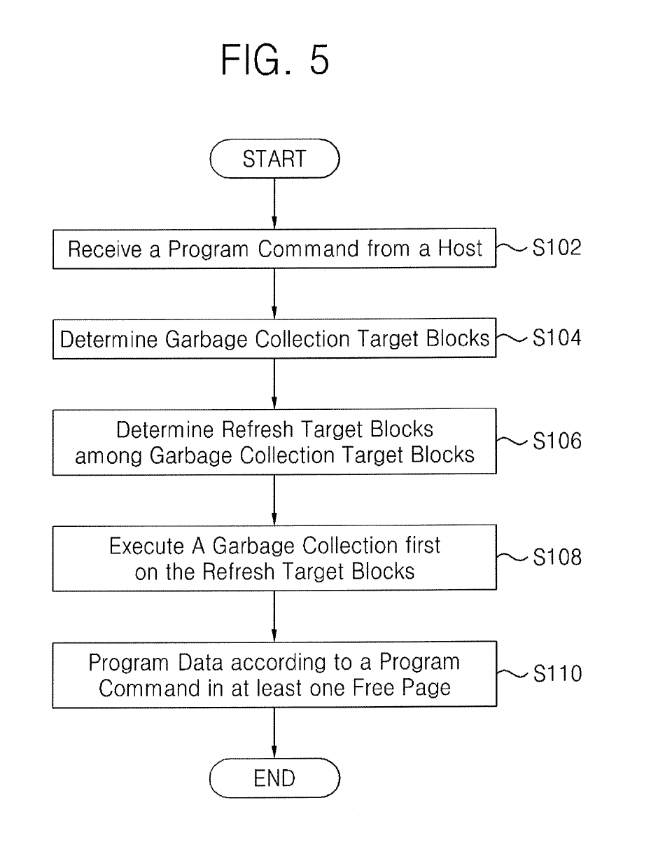

FIG. 5 illustrates a flowchart of an operation method of a memory controller illustrated in FIG. 1. Referring to FIGS. 1, 4 and 5, when a program command is received from a host (S102), the garbage collection block determination unit 52 of the memory controller 50 determines data blocks needing a garbage collection, i.e., garbage collection target blocks, according to a said reference (S104). When garbage collection blocks are determined, the refresh block determination unit 54 of the memory controller 50 determines data blocks needing refresh among the garbage collection target blocks, i.e., refresh target blocks, according to the described references (S106).

When the refresh target blocks are determined, the garbage collection execution unit 56 of the memory controller 50 executes a garbage collection first on the refresh target blocks among a plurality of data blocks included in the flash memory 60 (S108). When the garbage collection is performed, an invalid page is disappeared and a free page is occurred.

The memory controller 50 programs data according to a program command in at least one free page (S110). Here, a free page where data are programmed according to a program command may be a free page newly occurred by a garbage collection performed at S108. A free page where the data are programmed according to an exemplary embodiment may be a free page corresponding to address information included in the program command.

It is explained that the memory controller 50 determines garbage collection target blocks when a program command is received from a host in FIG. 5, however, the memory controller 50 may determine a garbage collection target block and a refresh target block at every period set in advance under a control of the CPU 30 and perform a garbage collection on the refresh target block.

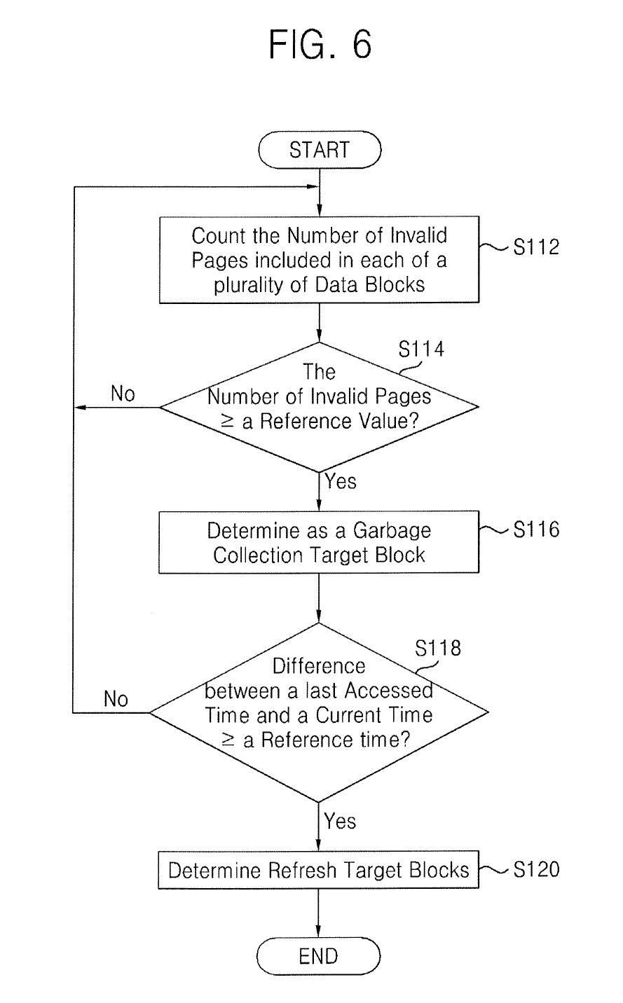

FIG. 6 illustrates a flowchart of a method of determining a garbage collection target block and a refresh target block among operation methods of the memory controller illustrated in FIG. 5. Referring to FIGS. 1, 4, 5 and 6, the garbage collection block determination unit 52 of the memory controller 50 counts the number of invalid page included in each of a plurality of data blocks included in the flash memory 60 (S112). When the number of invalid page is equal to or greater than a reference value set in advance (S114: Yes), the garbage collection block determination unit 52 determines a corresponding data block as a garbage collection target block (S118). Meanwhile, when the number of invalid pages is less than the reference value set in advance (S114: No), the garbage collection block determination unit 52 does not determine a corresponding data block as a garbage collection target block.

When a garbage collection target block is determined, the refresh block determination unit 54 determines if difference between a last accessed time of the garbage collection target block and a current time is greater than a reference time (S118). Accordingly, the refresh block determination unit 54 may record a last accessed time of pages included in each of a plurality of blocks in the page mapping database 58. When difference between the last accessed time and the current time is equal to or greater than the reference time (S118: Yes), the refresh block determination unit 54 determines a corresponding garbage collection target block as a refresh target block (S120). Meanwhile, when difference between the last accessed time and the current time is less than the reference time (S118: No), the refresh block determination unit 54 does not determine a corresponding garbage collection target block as a refresh target block.

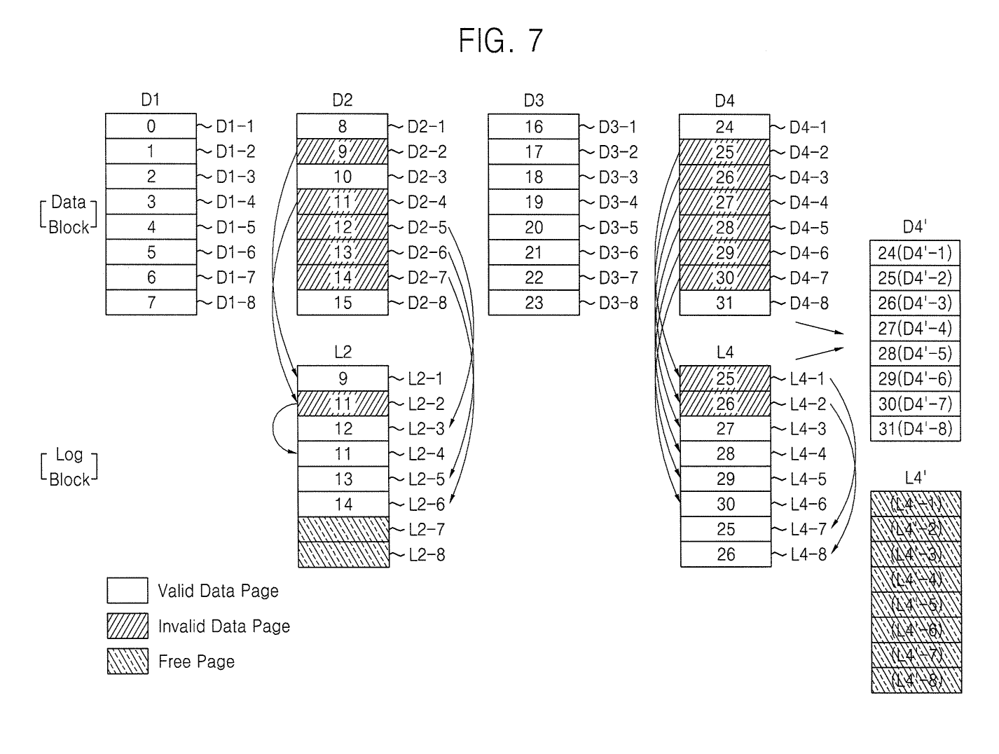

FIG. 7 illustrates data blocks where a garbage collection is performed in a flash memory according to an exemplary embodiment of the present general inventive concept. FIG. 7 illustrates a case performing a garbage collection by data block.

Referring to FIG. 7, for example, the flash memory 60 includes four data blocks D1, D2, D3 and D4, and two log blocks L2 and L4. The log blocks L2 and L4 may be utilized to update data of the flash memory 60. When there is no free page in data blocks D2 and D4, log blocks L2 and L4 corresponding to data blocks D2 and D4 are data blocks programming data instead of the data blocks D2 and D4. FIG. 7 illustrates only log blocks L2 and L4 corresponding to data blocks D2 and D4, however, each of all the data blocks D1 to D4 included in the flash memory 60 may have one or more corresponding log blocks.

Each of the data blocks D1 to D4 of FIG. 7 includes 8 pages D1-1 to D1-8, D2-1 to D2-8, D3-1 to D3-8 or D4-1 to D4-8. Address information may be mapped, respectively, in each page D1-1 to D1-8, D2-1 to D2-8, D3-1 to D3-8 or D4-1 to D4-8 included in each data block D1 to D4. For example, pages D1-1 to D1-8 of a data block D1 may be mapped with address information of each address 0 to 7, respectively. Likewise, pages D2-1 to D2-8 of a data block D2 may be mapped with address information of an address 8 to 15, respectively, pages D3-1 to D3-8 of a data block D3 may be mapped with address information of an address 16 to 23, respectively and pages D4-1 to D4-8 of a data block D4 may be mapped with address information of an address 24 to 31, respectively.

Referring to FIG. 7, data of a page D2-2 corresponding to an address 9 of a data block D2 are refreshed and programmed in a page L2-1 included in a log block L2. Accordingly, the page D2-2 corresponding to an address 9 becomes an invalid page and the page (L2-1) of the log block L2 becomes a valid page.

The page D2-2 is an invalid page, so that an address 9, address information, is newly mapped to the page L2-1. Data of a page D2-4 corresponding to an address 11 of the data block D2 are refreshed and programmed in a page L2-2 included in the log block L2. However, page L2-2, which was initially targeted to store the data corresponding to the data of D2-2, may be an invalid page. Accordingly, the data corresponding to address 11 may be re-programmed in a page L2-4 of the log block L2.

In addition, data of a page D2-5 corresponding to an address 12 of the data block D2 is refreshed and newly programmed in a page L2-3 included in the log block L2. Data of a page D2-6 corresponding to an address 13 of the data block D2 are also refreshed and programmed in a page L2-5 included in the log block L2, and data of a page D2-7 corresponding to an address 14 of the data block D2 are refreshed and programmed in a page L2-6 included in the log block L2.

Data of a page D4-2 corresponding to an address 25 of a data block D4 are refreshed and programmed in a page L4-1 included in a log block L4, and programmed in a page L4-7 of a log block L4 again. Accordingly, the pages D4-2 and L4-1 become invalid pages. Data of a page D4-3 corresponding to an address 26 of a data block D4 are refreshed and programmed in a page L4-2 included in the log block L4, and programmed in a page L4-2 of a log block L4 again.

Data of a page D4-4 corresponding to an address 27 of the data block D4 are refreshed and newly programmed in a page L4-3 included in the log block L4. Additionally, data of a page D4-4 corresponding to an address 27 of the data block D4 are refreshed and newly programmed in a page L4-3 included in the log block L4, and data of a page D4-5 corresponding to an address 28 of the data block D4 are refreshed and programmed in a page L4-4 of the log block L4.

Moreover, data of addresses 29 and 30 of the data block D4 are refreshed and newly programmed in a page L4-5 and a page L4-6 of the log block L4. Accordingly, there are increased the number of invalid pages and no free pages in a data block D4. In addition, there are no free pages available in the log block L4 corresponding to the data block D4 since pages L4-1 and L4-2 of log block L4 were initially invalid pages. In such a case, a garbage collection on the data block D4 is required.

Once a garbage collection on the data block D4 is performed by a garbage collection execution unit 56, only data programmed in valid pages D4-1, D4-8, L4-3, L4-4, L4-5, L4-6, L4-7 and L4-8 of the data block D4 and the log block L4 are newly programmed in a data block D4′.

Accordingly, addresses 24 to 31 are mapped in pages D4′-1 to D4′-8 of the data block D4′ respectively as address information of each page, and a log block L4′ corresponding to the data block D4′ includes free pages L4′-1 to L4′-8 since there is no programmed data. In addition, pages D4-1 to D4-8 and L4-1 to L4-8 of a data block D4 and a log block L4 where a garbage collection is performed become free pages since data are erased by the garbage collection.

According to an exemplary embodiment, the memory controller 50 may perform a garbage collection on a data block based on the number of invalid pages included in a data block. For example, a garbage collection may be performed when the number of invalid pages among data blocks, e.g., D1 to D4 and/or log blocks, e.g., L2, L4, is more than a reference value. For example, when the reference value is assumed to be ‘6’ in FIG. 7, the number of invalid pages of a data block D2 is ‘5’, so that a garbage collection on the data block D2 is not performed. Meanwhile, since the number of invalid pages of a data block D4 is ‘6’, the memory controller 50 performs a garbage collection on the data block D4.

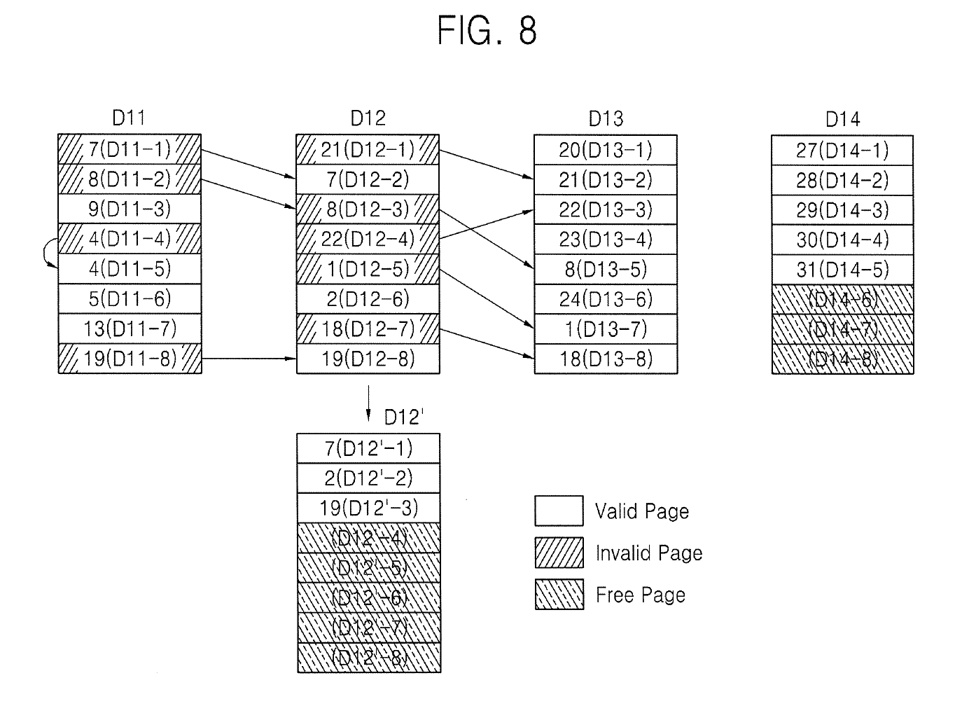

FIG. 8 illustrates data blocks where a garbage collection is performed in a flash memory according to another exemplary embodiment of the present general inventive concept. FIG. 8 illustrates a case where a garbage collection is performed based on at least one page. Referring to FIG. 8, for example, the flash memory 60 includes four data blocks D11 to D14. It is assumed that an order in which data are programmed in FIG. 8 is the same as an order in which pages are arranged in data blocks D11 to D14.

In other words, an order in which data are programmed in FIG. 8 may be arranged in an order of address information and a page corresponding to the address information as follows. 7(D11-1)->8(D11-2)->9(D11-3)->4(D11-4)->4(D11-5)->5(D11-6)->13(D11-7)->19(D11-8)->21(D12-1)->7(D12-2)->8(D12-3)->22(D12-4)->1(D12-5)->2(D12-6)->18(D12-7)->19(D12-8)->20(D13-1)->21(D13-2)->22(D13-3)->23(D13-4)->8(D13-5)->24(D13-6)->1(D13-7)->18(D13-8)->27(D14-1)->28(D14-2)->29(D14-3)->30(D14-4)->31(D14-5). Moreover, pages D14-6 to D14-8 of a data block D14 are free pages.

According to an exemplary embodiment, the memory controller 50 may perform a garbage collection on a data block where the number of invalid pages is equal to or more than a reference value among data blocks D11 to D14. For example, when the reference value in FIG. 8 is assumed to be ‘5’, the number of invalid pages in a data block D12 is ‘5’, so that the memory controller 50 performs a garbage collection on the data block D12. Meanwhile, since the number of invalid pages of a data block D11 is ‘4’, the memory controller 50 may not perform a garbage collection on the data block D11.

Referring to FIGS. 7 and 8, the memory controller 50 may prevent data stored in data blocks from being erased by performing a garbage collection on data blocks corresponding to refresh target blocks among garbage collection target blocks. In addition, it may manage a plurality of data blocks included in the flash memory 60 efficiently and help more data to be stored in the flash memory 60 by erasing an invalid page and generating a free page.

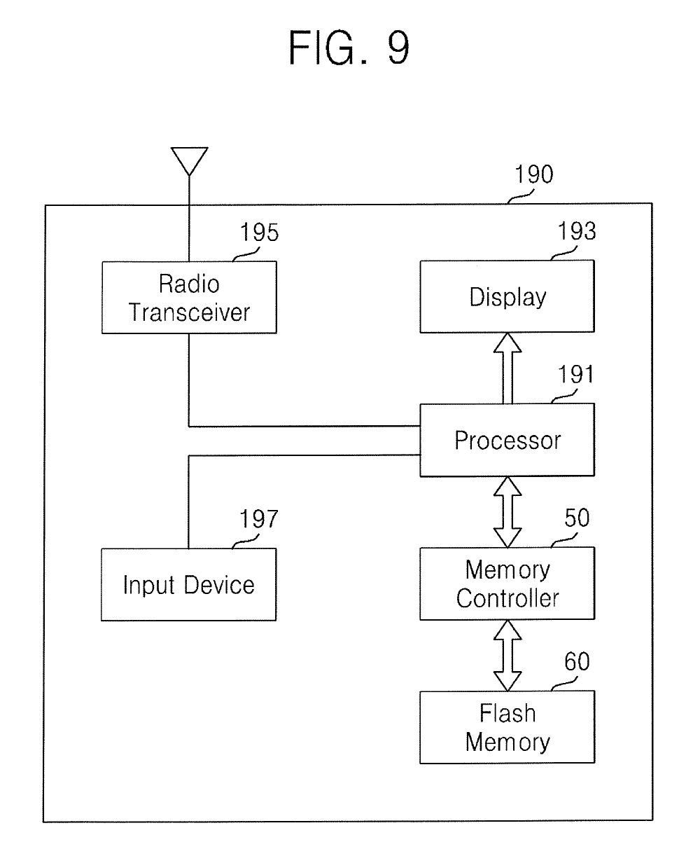

FIG. 9 illustrates an exemplary embodiment of an electronic device including the memory controller illustrated in FIG. 1. Referring to FIG. 9, the electronic device 190 which may be embodied in a cellular phone, a smart phone, a tablet personal computer (PC), a portable communication device, or a wireless internet device may include the flash memory 60 and the memory controller 50 which may control an operation of the flash memory 60. The memory controller 50 is also controlled by a processor 191 controlling a general operation of the electronic device 190. The memory controller 50 may perform a garbage collection under a control of the processor 191.

Data stored in the flash memory 60 may be displayed through a display 193 under a control of the processor 191. The radio transceiver 195 may transmit or receive radio signals through an antenna ANT. For example, the radio transceiver 195 may convert radio signals received through an antenna ANT into signals that the processor 191 may process. Accordingly, the processor 191 may process signals output from the radio transceiver 195 and store processed signals in the flash memory 60 or display them through the display 193.

Moreover, the radio transceiver 195 may convert signals output from the processor 191 into radio signals and output converted radio signals to outside through an antenna ANT.

The input device 197 is a device which may input control signals to control an operation of the processor 191 or data to be processed by the processor 191. It may be embodied in a pointing device such as a touch pad and a computer mouse, a keypad or a keyboard.

The processor 191 may control an operation of the display 193 so that data output from the flash memory 60, radio signals output from the radio transceiver 195 or data output from the input device 197 may be displayed through the display 193.

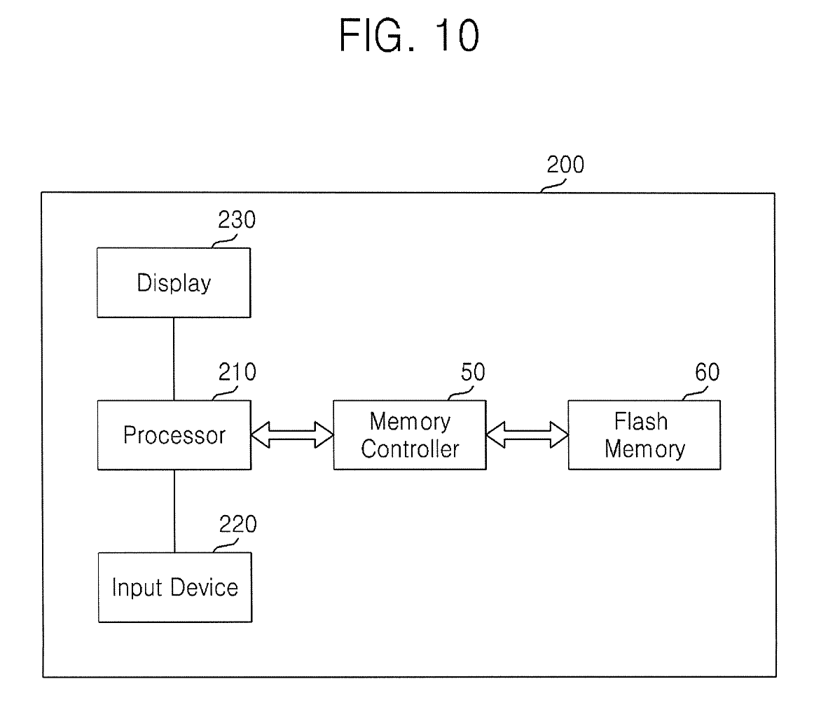

FIG. 10 illustrates another exemplary embodiment of the electronic device including the memory controller illustrated in FIG. 1. Referring to FIG. 10, the electronic device 200 which may be embodied in a data processing device such as a personal computer (PC), a tablet computer, a laptop computer, a net-book, an e-reader, a personal digital assistant (PDA), a portable multimedia player (PMP), a MP3 player or a MP4 player includes the flash memory 60 and the memory controller 50 controlling an operation of the flash memory 60.

Additionally, the electronic device 200 may include a processor 210 to control a general operation of the electronic device 200. The memory controller 50 is controlled by the processor 210 to control a general operation of the electronic device 200. For example, the memory controller 50 may perform a garbage collection under a control of the processor 210.

The processor 210 may display data stored in the flash memory 60 through a display 230 according to an input signal generated by an input device 220. For example, the input device 220 may be embodied in a pointing device such as a touch pad or a computer mouse, a keypad or a keyboard.

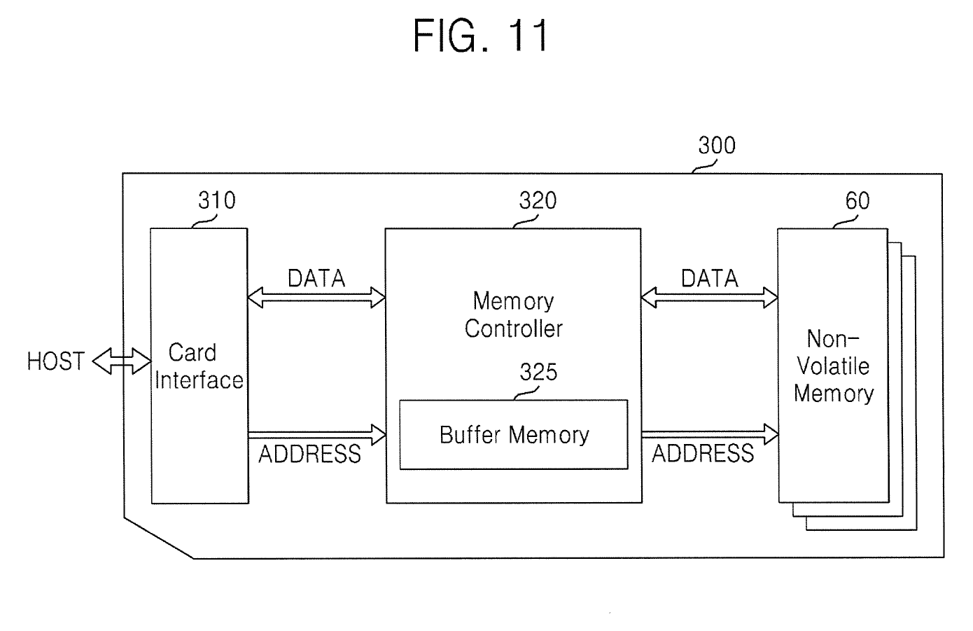

FIG. 11 illustrates still another exemplary embodiment of the electronic device including the memory controller illustrated in FIG. 1. Referring to FIG. 11, the electronic device 300 includes a card interface 310, a memory controller 320, at least one non-volatile memory 60, e.g., a flash memory.

The electronic device 300 may transmit or receive data with a host through a card interface 310. According to an exemplary embodiment, the card interface 310 may be a secure digital (SD) card interface or a multi-media card (MMC) interface, however, it is not restricted thereto. The card interface 310 may interface data exchange between a host and a memory controller 320 according to a communication protocol of a host which may communicate with the electronic device 300.

The memory controller 320 may control a general operation of the electronic device 300 and control data exchange between the card interface 310 and the non-volatile memory device 60. In addition, a buffer memory 325 of the memory controller 320 may buffer data transmitted or received between the card interface 310 and the non-volatile memory device 330.

The memory controller 320 is connected to the card interface 310 and the non-volatile memory 60 through a data bus DATA and an address bus ADDRESS. According to an exemplary embodiment, the memory controller 320 receives an address of data to read and/or to write from the card interface 310 through an address bus ADDRESS and transmits it to the non-volatile memory 60.

Moreover, the memory controller 320 receives or transmits data to read and/or to write through a data bus connected to each of the card interface 310 and the non-volatile memory 60. According to an exemplary embodiment, the memory controller 320 illustrated in FIG. 11 may perform an identical or similar function of the memory controller 50 illustrated in FIG. 1. Accordingly, the memory controller 320 may perform a garbage collection according to an exemplary embodiment of the present general inventive concept.

Various kinds of data are stored in at least one non-volatile memory 60. According to an exemplary embodiment, a read operation and/or a write operation may be performed simultaneously in the at least one non-volatile memory 60. Here, a memory cell array of the non-volatile memory 60 where a read operation is performed may be different from a memory cell array of the non-volatile memory 60 where a write operation is performed.

When the electronic device 300 of FIG. 11 is connected to a host such as a computer, a digital camera, a digital audio player, a cellular phone, console video game hardware or a digital set-top box, the host may receive or transmit data stored in at least one non-volatile memory 60 through the card interface 310 and the memory controller 320.

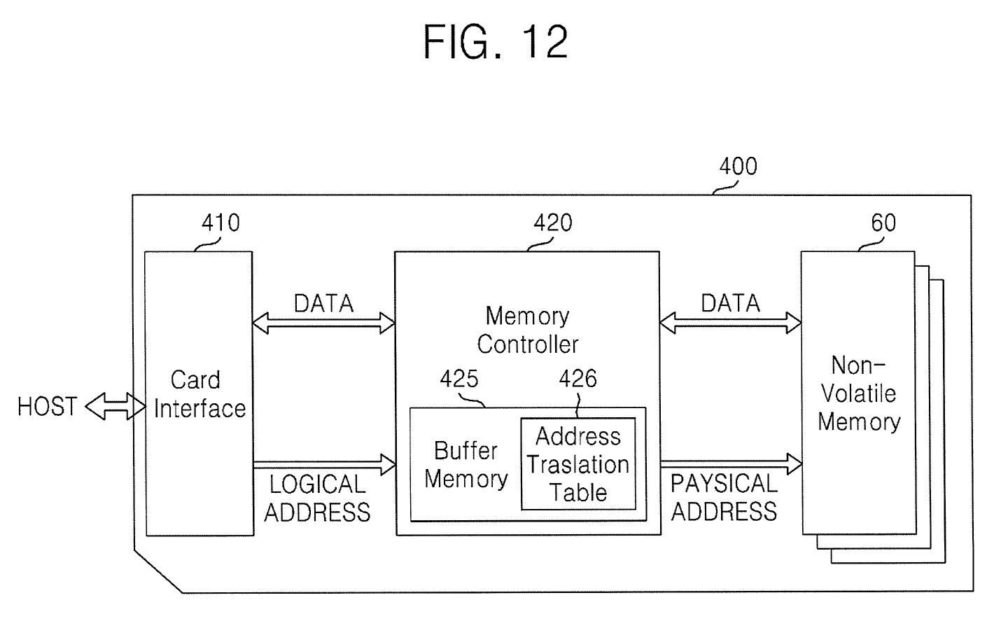

FIG. 12 illustrates still another exemplary embodiment of the electronic device including the memory controller illustrated in FIG. 1. Referring to FIG. 12, an electronic device 400 includes a card interface 410, a memory controller 420, at least one non-volatile memory 60, e.g., a flash memory.

The electronic device 400 may perform a data communication with a host through the card interface 410. According to an exemplary embodiment, the card interface 410 may be a secure digital (SD) card interface or a multi-media card (MMC) interface, however, it is not restricted thereto. The card interface 410 may perform a data communication between a host and the memory controller 420 according to a communication protocol of a host which may communicate with the electronic device 400.

The memory controller 420 may control a general operation of the electronic device 400 and control data exchange between the card interface 410 and the at least one non-volatile memory 60.

The buffer memory 425 included in the memory controller 420 may store various kinds of data to control a general operation of the electronic device 400. The memory controller 420 may be connected to the card interface 410 and the non-volatile memory 60 through a data bus DATA and a logical address bus. According to an exemplary embodiment, the memory controller 420 may receive an address of data to read and/or to write from the card interface 410 through a logical address bus, and transmit it to the non-volatile memory 60 through a physical address.

The memory controller 420 may also receive and/or transmit data to read and/or to write through a data bus connected to each of the card interface 410 and the non-volatile memory 60. The memory controller 420 may perform an identical or similar function of the memory controller 50 illustrated in FIG. 1. Accordingly, the memory controller 420 may perform a garbage collection according to an exemplary embodiment of the present general inventive concept.

In the at least one non-volatile memory 60, various kinds of data are stored. According to an exemplary embodiment, an address translation table 426 may be included in the buffer memory 425, as described below, such that a read operation and a write operation may be performed simultaneously in the at least one non-volatile memory 60. Here, a memory cell array of the non-volatile memory 60 where a read operation is performed may be different from a memory cell array of the non-volatile memory 60 where a write operation is performed.

According to an exemplary embodiment, the memory controller 420 of the electronic device 400 may include an address translation table 426 inside the buffer memory 425. In the address translation table, a logical address input from outside and a logical address to access to the non-volatile memory 60 may be included. During a write operation, the memory controller 420 may write new data on an arbitrary physical address and update the address translation table 426.

The memory controller 420 may select a physical address which may perform a read operation along with a write operation by referring to a physical address of data where a write operation is performed from the address translation table 426. The memory controller 420 may perform the write operation and the read operation together and update the address translation table 426 according to the write operation and the read operation. Accordingly, an operation time of the electronic device 400 may be reduced.

When the electronic device 400 of FIG. 12 is connected to a host such as a computer, a digital camera, a digital audio player, a cellular phone, a video game console or a digital set-top box, the host may transmit or receive data stored in the at least one non-volatile memory 60 through the card interface 410 and the memory controller 420.

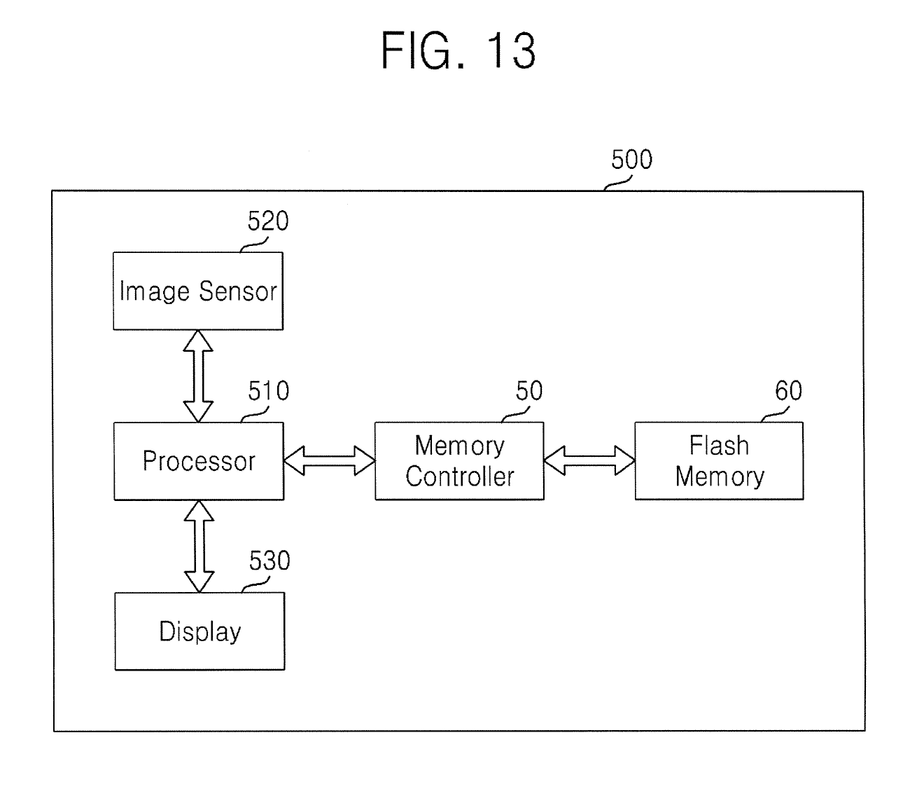

FIG. 13 illustrates still another exemplary embodiment of an electronic device including the memory controller illustrated in FIG. 1, and an image sensor 520 to record images, including but not limited to, still images and moving images. Referring to FIG. 13, an electronic device 500 includes the flash memory 60, the memory controller 50 to control a data processing operation of the flash memory 60, and a processor 510 controlling a general operation of the electronic device 500. The memory controller 50 may perform a garbage collection according to an exemplary embodiment under a control of the processor 510.

The image sensor 520 of the electronic device 500 converts an optical image into digital signals, and converted digital signals are stored in the flash memory 60 or displayed through a display 530 under a control of the processor 510. In addition, the digital signals stored in the flash memory 60 are displayed through the display 530 under a control of the processor 510.

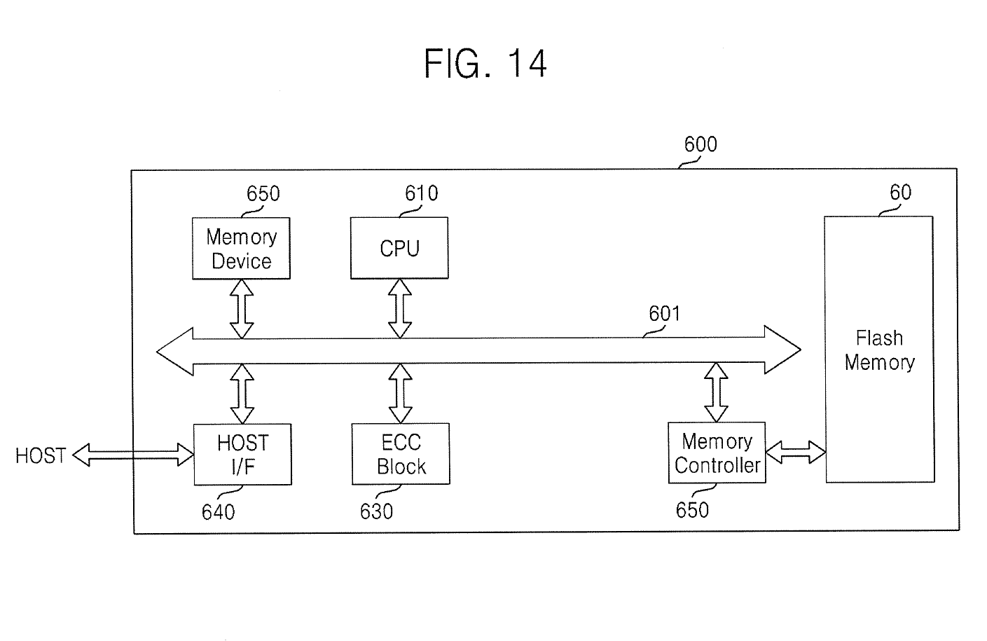

FIG. 14 illustrates still another exemplary embodiment of the electronic device including the memory controller illustrated in FIG. 1. Referring to FIG. 14, an electronic device 600 includes the flash memory 60, the memory controller 50 to control an operation of the flash memory 60, and a CPU 610 controlling a general operation of the electronic device 600.

The electronic device 600 includes a memory device 650 which may be used as an operation memory of the CPU 610. The memory device 650 may be embodied in a non-volatile memory like a ROM or a volatile memory like a DRAM.

The host connected to the electronic device 600 may transmit and/or receive data with the flash memory through the memory controller 50 and a host interface 640. The host interface may include, but is not limited to, a USB interface such that the host may be connected to the electronic device 600 via a USB connection. Here, the memory controller 50 may perform a function of a memory interface, e.g., a flash memory interface. The memory controller 50 may perform a garbage collection according to an exemplary embodiment of the present general inventive concept under a control of the CPU 610.

The error correction code (ECC) block 630 operating according to a control of the CPU 610 may detect and correct an error included in data read from the memory device 60 through the memory controller 50. The CPU 610 may control data exchange among the memory controller 50, the ECC block 630, the host interface 640 and the memory device 650 through a bus 601. The electronic device 600 may be embodied in a universal serial bus (USB) memory drive or a memory stick.

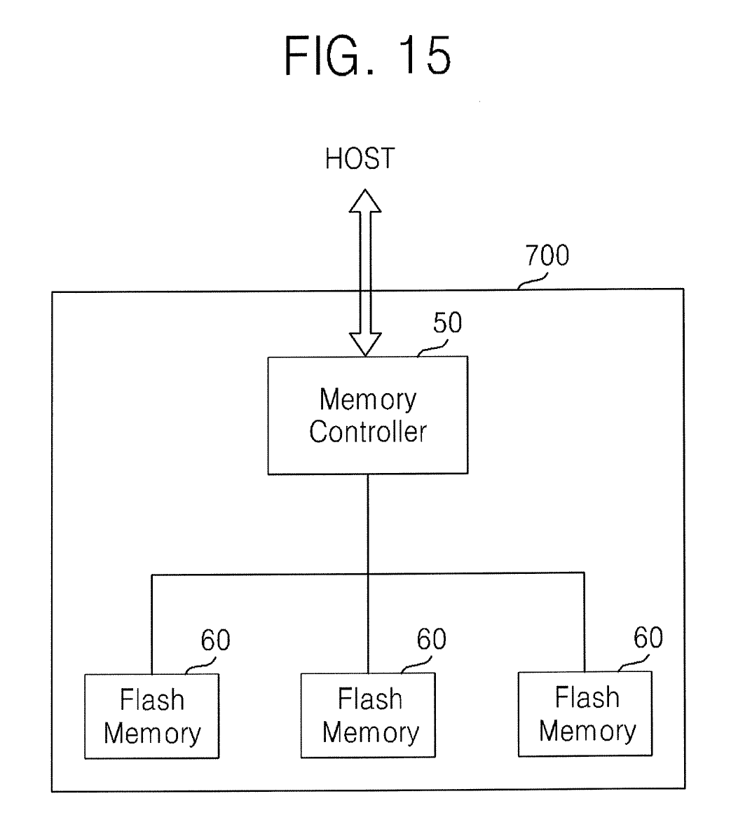

FIG. 15 illustrates still another exemplary embodiment of the electronic device including the memory controller illustrated in FIG. 1. Referring to FIG. 15, an electronic device 700 may be embodied in a data storage device like a solid state drive (SSD). The electronic device 700 may include a plurality of flash memories 60-1 to 60-m and the memory controller 50 controlling each data processing operation of the plurality of flash memories 60-1 to 60-m. The electronic device 700 may be embodied in a memory system or a memory module. According to an exemplary embodiment, the memory controller 50 may be embodied inside or outside the electronic device 700.

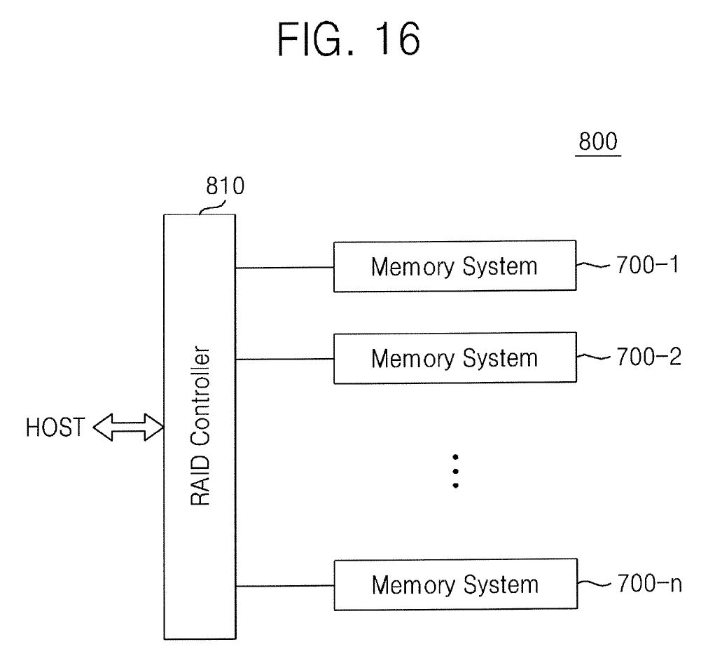

FIG. 16 illustrates an exemplary embodiment of a data processing device including the electronic device illustrated in FIG. 15. Referring to FIGS. 15 and 16, a data storage device 800 which may be embodied in a redundant array of independent disks (RAID) system may include a RAID controller 810 and a plurality of memory systems 700-1 to 700-n, where n is a natural number. Each of the plurality of memory systems 700-1 to 700-n may be the electronic device 700 illustrated in FIG. 15. The plurality of memory systems 700-1 to 700-n may compose a RAID array. The RAID array provides a data storage scheme that can divide and replicate data among the memory systems 700-1-700-n. The data storage device 800 may be embodied in a personal computer (PC) or a SSD.

During a program operation, the RAID controller 810 may output program data output from a host to one of the plurality of memory systems 700-1 to 700-n according to a RAID level selected based on RAID level information output from the host among a plurality of RAID levels. Additionally, during a read operation, the RAID controller 810 may transmit data read from one of the plurality of memory systems 700-1 to 700-n according to a RAID level selected based on RAID level information output from the host among a plurality of RAID levels.

A memory device according to an exemplary embodiment of the present general inventive concept may manage data stored in a flash memory efficiently by first performing a garbage collection on data blocks needing refresh.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An operation method of a memory device comprising:
determining first data blocks needing a garbage collection;
determining second data blocks needing refresh among determined first data blocks; and
performing the garbage collection first on the second data blocks.

2. The operation method of claim 1, wherein the determining the first data blocks comprises determining data blocks where a number of invalid pages among a plurality of pages included in each of a plurality of data blocks is at least one of equal to and more than a reference value as the first data blocks.

3. The operation method of claim 1, wherein the determining the second data blocks comprises determining data blocks including a page where a difference between a last accessed time of a plurality of pages, which are included in each of the first data block, and a current time is equal to or greater than a reference time as the second data blocks.

4. A memory device comprising:
a flash memory including a plurality of data blocks; and
a memory controller determining first data blocks needing a garbage collection among the plurality of data blocks, determining second data blocks needing refresh among the first data blocks and performing the garbage collection first on the second data blocks.

5. The memory device of claim 4, wherein the memory controller comprises:
a garbage collection block determination unit determining the first data blocks among the plurality of data blocks;
a refresh block determination unit determining the second data blocks among the first data blocks; and
a garbage collection execution unit performing the garbage collection on the second data blocks first.

6. The memory device of claim 5, wherein the garbage collection block determination unit determines data blocks where a number of invalid pages among a plurality of pages included in each of the plurality of data blocks is at least one of equal to and more than a reference value as the first data blocks.

7. The memory device of claim 5, wherein the refresh block determination unit determines data blocks including a page where difference between a last accessed time and a current time is equal to or greater than a reference time among a plurality of pages included in each of the first data blocks as the second data blocks.

8. The memory device of claim 5, wherein the memory controller further comprises a page mapping database storing mapping information of at least one valid page included in each of the plurality of data blocks,
wherein a last accessed time of the at least one valid page included in each of the plurality of data blocks is stored in the page mapping database, and
the refresh block determination unit determines the second data blocks by comparing the last accessed time of the at least one valid page with a current time.

9. An electronic device comprising:
the memory device of claim 4; and
a processor to control an operation of the memory device.

10. The electronic device of claim 9, wherein the memory controller comprises:
a garbage collection block determination unit determining data blocks where a number of invalid pages among a plurality of pages included in each of the plurality of data blocks is at least one of equal to and more than a reference value as the first data blocks;
a refresh block determination unit determining data blocks including a page where a difference between a last accessed time and a current time is equal to or greater than a reference time among a plurality of pages included in each of the first data blocks as the second data blocks; and
a garbage collection execution unit performing the garbage collection first on the second data blocks.

11. The electronic device of claim 9, wherein the electronic device is a PC, a tablet PC, a solid state drive (SSD) or a cellular phone.

12. A memory card comprising:
a card interface; and
a second memory controller controlling data exchange between the card interface and the memory controller of claim 4.

13. The memory card of claim 12, wherein the memory controller comprises:
a garbage collection block determination unit determining data blocks where a number of invalid pages among a plurality of pages included in each of the plurality of data blocks is at least one of equal to and more than a reference value as the first data blocks;
a refresh block determination unit determining data blocks including a page where a difference between a last accessed time and a current time is equal to or greater than a reference time among a plurality of pages included in each of the first data blocks as the second data blocks; and
a garbage collection execution unit performing the garbage collection first on the second data blocks.

14. A memory device comprising:
a flash memory having a plurality of data blocks including a plurality of garbage collection blocks and a plurality of refresh blocks among the garbage collection blocks; and
a memory controller to set at least one priority level of the plurality of refresh blocks and at least one priority level of the plurality of garbage collection blocks, and to perform a garbage collection based on the at least one priority levels.

15. The memory device of claim 14, wherein the at least one priority level of the refresh blocks is greater than the at least one priority level of the garbage collection blocks, and wherein the memory controller performs the garbage collection on the plurality of refresh blocks based on each of the at least one priority level before performing a refresh on the plurality of garbage collection blocks.

16. The memory device of claim 14, wherein the at least one priority level of the refresh blocks includes a first priority level based on a number of invalid pages among the refresh blocks being more than a reference value, and a page among the refresh blocks that has a difference between a last accessed time and a current time being more than a reference time.

17. The memory device of claim 16, wherein the at least one priority level of the refresh blocks includes a second priority level based on a page among the refresh blocks that has a difference between a last accessed time and a current time being more than a reference time

18. The memory device of claim 17, wherein the at least one priority level of the garbage collection blocks includes a third priority level data based on a number of invalid pages among the garbage collection blocks being at least one of equal to and more than a reference value.

19. The memory device of claim 18, wherein the second priority level is greater than the third priority level and the first priority level is greater than each of the second and third priority levels.
